(19) United States
(12) Patent Application Publication
(10) Pub. No.: US 2009/0164174 A1
(43) Pub. Date: Jun. 25, 2009

(54) SOLAR SYSTEM AUTOMATIC SIZING AND FAILURE IDENTIFICATION ON LOCATION USING RESIDENT GPS RECEIVER

(76) Inventors: James Bears, Palm City, FL (US); Michael Sonnenfeldt, New York, NY (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/341,458

(22) Filed: Dec. 22, 2008

Related U.S. Application Data
(60) Provisional application No. 61/016,066, filed on Dec. 21, 2007.

(51) Int. Cl. G01D 1/18; H01J 7/42; G06F 1/28

(52) U.S. Cl. 702/188; 315/129; 116/202; 700/295; 700/296

(57) ABSTRACT

A method of operating an electrical appliance includes coupling a solar collector to the electrical appliance such that the solar collector may provide electrical power to the appliance. A global positioning system receiver is used to determine a location of the solar collector. A level of power that may be sourced by the solar collector is calculated wherein the calculation is dependent upon the location of the solar collector as determined by the global positioning system receiver. The appliance is configured to draw a level of power corresponding to the calculated level of power that may be sourced by the solar collector.

### RELATED APPLICATION

The present invention claims priority to U.S. Provisional Patent Application No. 61/016,066, entitled “SOLAR SYSTEM AUTOMATIC SIZING AND FAILURE IDENTIFICATION ON LOCATION USING RESIDENT GPS RECEIVER”, filed Dec. 21, 2007, which is incorporated herein by reference.

### BACKGROUND OF THE INVENTION

1. Field of the Invention

The present invention relates generally to global positioning systems (GPS) and, more particularly, global positioning systems used in conjunction with solar panels and/or street lights.

2. Description of the Related Art

Solar panels, or other forms of solar energy collectors, are used in providing electrical power to street lights and other electrical appliances. The amount of power that the solar panel is able to source is dependent to a large part upon the incident angle of the sun's rays on the solar panel, the amount of the earth's atmosphere through which the sun's rays travel to reach the solar panel, and the length of time per day that the solar panel is exposed to sunlight. These factors, in turn, are largely dependent upon the location of the solar panel on the earth and the tilt of the earth's rotation, i.e., the current date on the calendar. Because of the variability of these factors, the amount of power that the solar panel is able to source is likewise variable. The variability of the power sourced by the solar panel makes it necessary, in order to ensure proper operation of the appliance, to maintain the current draw of the appliance at a low level to avoid drawing more power than the solar panel is able to provide under the most unfavorable conditions. However, maintaining the current draw of the appliance at a low level may compromise the performance of the appliance under all conditions.

One type of appliance that may use solar panels is a street light, although it is also possible for a street light to be powered by a conventional grid system, i.e., a street light may be conventionally grid tied. Street lights, however powered, are typically widely geographically dispersed, and thus their operation is difficult to observe and verify. Because of the difficulty of monitoring street lights, if a street light fails, it may take an extended period of time for the appropriate personnel to learn of the failure, identify its location, and determine what parts are required to make the repair.

### SUMMARY OF THE INVENTION

The present invention is directed, in one embodiment, to a solar panel equipped with a GPS receiver that determines both the current date and the location on the surface of the earth at which the solar panel is installed. An on-board processor may use the GPS data and the specifications of the solar panel to determine the amount of electrical power that the solar panel is likely to source on any particular date at the location at which the solar panel is installed. An appliance powered by the solar panel may then be configured to draw a level of power that is commensurate with the level of power that the solar panel is able to source.

The present invention is directed, in another embodiment, to an appliance disposed in the field that is capable of determining when a failure of the appliance has occurred. The appliance is equipped with a GPS receiver such that the location of the appliance may be communicated with a central office once a failure has occurred. A failure mode of the appliance, and/or a list of parts needed to repair the appliance may also be communicated to the central office. Thus, the GPS receiver enables personnel at the central office to repair the appliance with minimal delay.

The present invention is directed, in another embodiment, to a mobile sensor that is powered by a solar collector and that is equipped with a global positioning system device. When the sensor detects an event, the location of the sensor, and hence the location of the event, is transmitted to a central receiver. The sensor may transmit a visible signal, such as a beam of light, to draw the attention of the occupants of a car or a plane who may be searching for the exact location of the event.

The invention comprises, in one embodiment thereof, a method of operating an electrical appliance, including coupling a solar panel to the electrical appliance such that the solar panel may provide electrical power to the appliance. A global positioning system receiver is used to determine a location of the solar panel. A level of power that may be sourced by the solar panel is calculated wherein the calculation is dependent upon the location of the solar panel as determined by the global positioning system receiver. The appliance is configured to draw a level of power corresponding to the calculated level of power that may be sourced by the solar panel.

The invention comprises, in another embodiment thereof, a method of operating a street light, including using a global positioning system to determine a location of the street light, and determining that the street light has failed or is likely to fail within a period of time. A radio frequency signal is transmitted to a central receiver. The signal indicates that the street light has failed or is likely to fail within a period of time. The signal also indicates the determined location of the street light.

The invention comprises, in yet another embodiment thereof, a sensing method including providing a sensor to detect an event. A current location of the sensor is ascertained by use of a global positioning system device. Electrical power is supplied to the sensor and/or the global positioning system device by use of a solar collector. A radio frequency signal is transmitted to a central receiver when the sensor detects the event. The signal includes the current location of the sensor. An advantage of the present invention is that the current draw of an appliance may be set to a level that matches the power sourcing capability of an associated solar collector.

Another advantage is that street lights that have failed, or are about to fail, may be quickly identified and repaired.

Yet another advantage is that the exact location of a sensed event may be determined by use of a mobile sensor.

### BRIEF DESCRIPTION OF THE DRAWINGS

The above-mentioned and other features and advantages of the invention will become more apparent to one with skill in the art upon examination of the following figures and detailed description. The components in the figures are not necessarily to scale, emphasis instead being placed upon illustrating the principles of the invention. Moreover, in the figures, like reference numerals designate corresponding parts throughout the different views.

FIG. 1 is a block diagram of one embodiment of a solar powered system of the present invention.

FIG. 2 is a block diagram of one embodiment of a street light with a failure mode identification arrangement of the present invention.

FIG. 3 is a block diagram of a solar powered sensor system of the present invention.

### DETAILED DESCRIPTION OF THE PRESENTLY PREFERRED EMBODIMENTS

The embodiments hereinafter disclosed are not intended to be exhaustive or limit the invention to the precise forms disclosed in the following description. Rather the embodiments are chosen and described so that others skilled in the art may utilize its teachings.

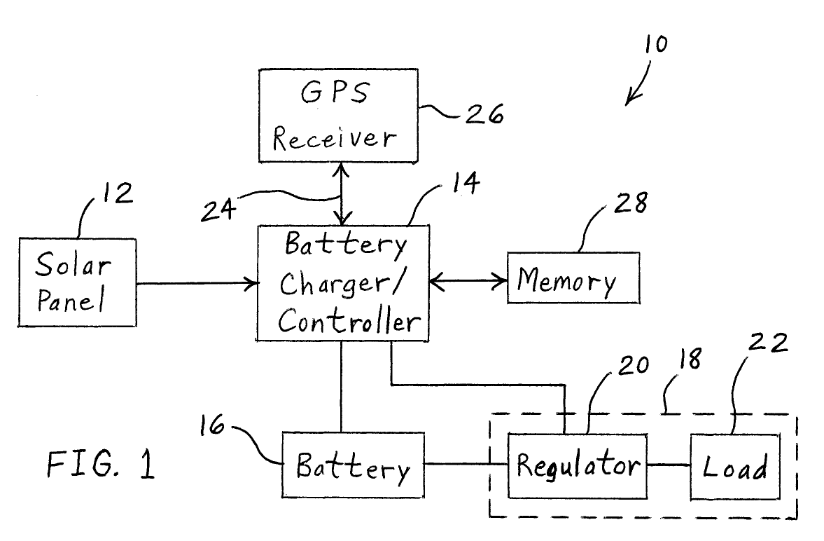

Referring to FIG. 1, there is shown a block diagram of one embodiment of a solar powered system 10 of the present invention including a solar panel 12, a battery charger/controller 14, and a battery 16 connected to an appliance 18. Appliance 18 may be in the form of a street light, for example. However, it is within the scope of the invention for appliance 18 to be any low-power electrical device, such as a sensor, electronic device or light source, for instance. Appliance 18 may include a regulator 20 for regulating the level of current drawn by a load 22 of appliance 18.

Controller 14 may be able to communicate via wires 24 or other signal medium with a locally resident GPS receiver 26. In one embodiment, GPS receiver 26 is wireless.

It may be desirable to have the GPS system turn off, or go to “sleep,” so that the power drain on the system is reduced. Hence, GPS receiver 26 may spend most of its time in a low-power-consuming sleep state, and may be turned on, or awakened from the sleep state, by controller 14.

The turning on of GPS receiver 26 and checking of the location of appliance 18 may be at the time of initial installation of appliance 18. In another embodiment, the turning on of GPS receiver 26 and checking of the location of appliance 18 may be scheduled at regular time intervals by a timer internal to controller 14, or by other means. Regularly turning on the GPS and checking the current location of appliance 18 may be beneficial if appliance 18 is mobile and the exposure of solar collector 12 to solar energy is accordingly variable.

A processor within controller 14 may access local data, such as stored in a table in resident memory in a memory device 28, to determine the amount of incident solar radiation for the particular location. The amount of incident solar radiation that may be collected may also depend upon an orientation of the solar collector, and this orientation may be measured and recorded. The orientation may be measured, for example, in terms of an angle with respect to the horizon. By an algorithm, the proper load power, or current draw of the system to match the solar panel size, or solar energy collecting capacity, may be calculated by the processor.

After calculating the proper load power or current, the processor may send a signal to regulator 20. Regulator 20 may then adjust the load power or current so that the solar powered system is properly sized for its geographic location and for the time of year. Proper sizing means that the amount of power withdrawn by appliance 18 during its operation is not too great for the sourcing capability of battery 16 or too great for battery 16 to be replenished by solar panel 12.

The turning on of GPS device 26 can be done once at installation or periodically during the year. For example, periodic adjustments may allow the load to be matched to the system to account for seasonal variation in the amount of incident solar radiation.

In a second embodiment, if a system is failing, or is about to fail, it may transmit its location utilizing the GPS, so that a repair crew can be dispatched. In one embodiment, the system includes a street light, which can be either solar powered or grid tied. This embodiment may save a repair crew a lot of time because the work order may be issued for the exact locations of the exact lights to be rep aired. Further, if the components that have failed, or that are about to fail, can be diagnosed or otherwise identified, then the work order may include a list of the exact parts needed to make the repairs. This list of repair parts may save the repair crew from making two separate trips to the failed street light, i.e., a first trip to diagnose the failure and identify the parts to be procured, and a second trip to repair the street light using the procured parts.

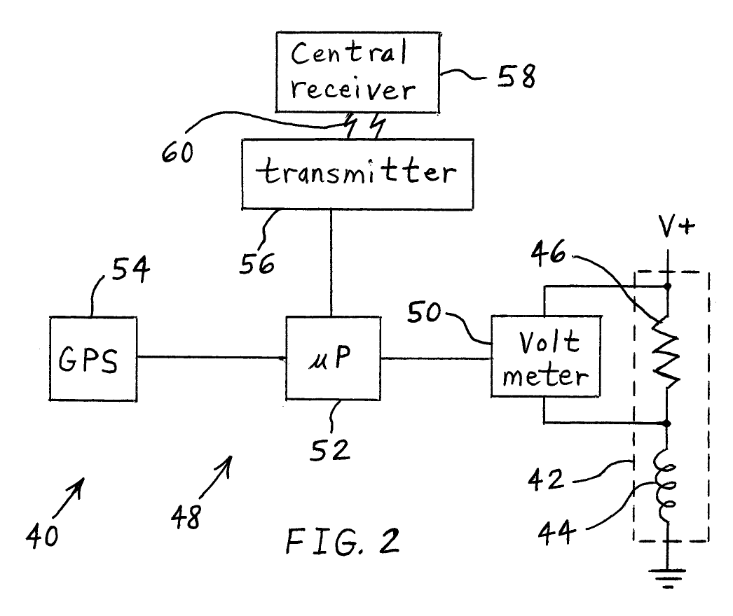

A block diagram of a street light system 40 of the second embodiment described above is illustrated in FIG. 2. Street light system 40 may include a street light 42 which may be powered by a voltage source V+. Voltage source V+ may be in the form of a solar collector or a grid tied voltage source. Voltage source V+ may include a voltage regulator (not shown) for providing a constant level of voltage to street light 42. Street light 42 may include a light filament 44 for emitting light when voltage is applied thereto. Filament 44 may be connected in series with a measurement resistor 46. The voltage V+ may be applied across the series combination of light filament 44 and resistor 46. Street light system 40 may include a failure mode identification arrangement 48 having a volt meter 50 for measuring the voltage applied across resistor 46.

In the event that filament 44 begins to fail, such as by becoming burnt out, its resistance may increase as it is less able to carry current. With a fixed voltage applied across the series combination of filament 44 and resistor 46, the voltage across resistor 46 as measured by volt meter 50 may decrease as the resistance of filament 44 increases as filament 44 begins to fail.

Failure mode identification arrangement 48 may also include a microprocessor 52 in communication with each of volt meter 50, GPS device 54, and radio frequency transmitter 56. GPS device 54 may periodically update processor 52 with the current global location of street light 42, as GPS device 54 may be disposed adjacent to street light 42.

If the voltage across resistor 46 as measured by volt meter 50 drops below a threshold level, then processor 52 may instruct transmitter 56 to transmit to a central receiver 58 a signal 60. Signal 60 may be indicative of the location of street light 42, may be indicative that street light 42 has failed or is about to fail, and may include a list of replacement parts, e.g., filament 44, that may be needed to repair street light 42. Signal 60 may also include the time of transmission of signal 60. A repair crew may be dispatched with the appropriate repair parts in response to receiver 58 receiving signal 60.

Radio frequency transmitter 56 may be in the form of a low power and/or low bandwidth satellite transmitter, cell phone or other form of wireless communication. It is to be understood that, as used herein, the term “radio frequency” encompasses low power satellite transmission frequencies and cell phone frequencies.

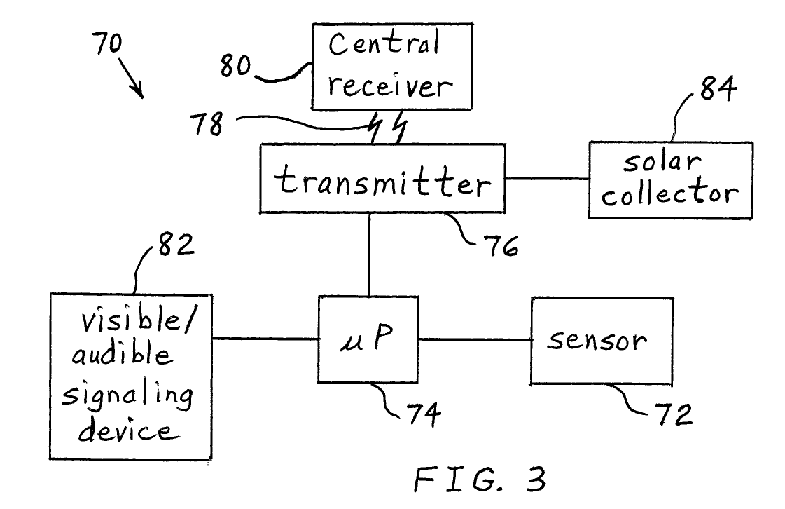

In yet another embodiment, a solar powered sensor system 70 (FIG. 3) includes a sensor 72 for sensing some event and sending a signal indicative thereof to microprocessor 74. Upon receiving the signal from sensor 72, processor 74 may cause a GPS transmitter 76 to transmit a signal 78 to a central receiver 80 either over a satellite network or other radio frequency network, such as a cellular network. Sensor 72 may be a motion detector, a water sensor (for detecting flash flooding), a light sensor (to detect that a car is approaching), a chemical sensor (to detect a chemical attack), a nuclear sensor, a biological sensor, a wind sensor, a temperature sensor, a humidity sensor, a noise sensor, a vibration sensor, an electrical current sensor, a radio frequency sensor, an infrared sensor, a temperature sensor, a smoke sensor, a sound sensor, an earthquake sensor, a vibration sensor, a radar sensor, or a video image recognition sensor, for example. A visible/audible signaling device 82 may be automatically activated to issue a visible and/or audible signal after sensor 72 senses an event. For example, visible/audible signaling device 82 may issue a light or sound or other signal to identify which unit has the alarm going off. The signal from visible/audible signaling device 82 may be detected locally, or by remote means. In one embodiment, processor 74 may activate signaling device 82 a predetermined period of time after sensor 72 senses the event. The signal issued by signaling device 82 may help a searcher, who may be in a car or airplane, for example, to quickly find the location of sensor 72. Transmitter 76, as well as any or all of sensor 72, processor 74, and signaling device 82, may be powered by a solar collector 84.

Transmitter 76 is described above as a GPS transmitter that can provide updates of the location of sensor 72. However, in another embodiment, the transmitter may be another type of transmitter which can transmit location information even if the location information was programmed into the controller when the sensor was installed. Transmitter 76 may include a satellite transmitter or a cell phone transmitter.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of operating an electrical appliance, the method comprising the steps of:
coupling a solar collector to the electrical appliance such that the solar collector may provide electrical power to the appliance;
using a global positioning system to determine a location of the solar collector;
calculating a level of power that may be sourced by the solar collector, the calculating being dependent upon the location of the solar collector as determined by the global positioning system; and
configuring the appliance to draw a level of power corresponding to the calculated level of power that may be sourced by the solar collector.

2. The method of claim 1, wherein the global positioning system determines a current calendar date, the calculating step being dependent upon the current calendar date.

3. The method of claim 1, comprising the further steps of:
loading date information into a processor; and
using the processor to keep track of a current date, the calculating step being dependent upon the current date.

4. The method of claim 1, wherein the appliance is configured to draw a level of power that is less than the calculated level of power that may be sourced by the solar collector.

5. The method of claim 1, comprising the further step of ascertaining an orientation of the solar collector, the calculating step being dependent upon the orientation of the solar collector.

6. A method of operating a street light, the method comprising the steps of:
using a global positioning system to determine a location of the street light;
determining that the street light has failed or is likely to fail within a period of time; and
transmitting a radio frequency signal to a central receiver, the signal indicating that the street light has failed or is likely to fail within a period of time, the signal also indicating the determined location of the street light.

7. The method of claim 6, comprising the further steps of ascertaining a list of parts needed to repair the street light, the radio frequency signal indicating the list of parts needed to repair the street light.

8. The method of claim 6, wherein the determining step includes measuring a level of current drawn by the street light.

9. The method of claim 6, comprising the further step of providing electrical power to the street light from a solar collector, the determining step comprising determining that at least one of the street light and the solar collector has failed or is likely to fail within a period of time.

10. A sensing method, comprising the steps of:
providing a sensor to detect an event;
ascertaining a current location of the sensor by use of a global positioning system device;
supplying electrical power to at least one of the sensor and the global positioning system device by use of a solar collector; and
transmitting a radio frequency signal to a central receiver when the sensor detects the event, the signal including the current location of the sensor.

11. The method of claim 10, comprising the further step of emitting a visible signal after the transmitting step.

12. The method of claim 11, wherein the emitting step includes emitting a light.

13. The method of claim 10, wherein the sensor comprises a motion detector.

14. The method of claim 10, wherein the sensor comprises a water sensor.

15. The method of claim 10, wherein the sensor comprises a light sensor.

16. The method of claim 10, wherein the sensor comprises a chemical sensor.

17. The method of claim 10, wherein the sensor comprises a nuclear sensor.

18. The method of claim 10, wherein the sensor comprises a biological sensor.

19. The method of claim 10, wherein the sensor comprises a wind sensor.

20. The method of claim 10, comprising the further steps of:
calculating a level of power that may be sourced by the solar collector, the calculating being dependent upon the location of the solar collector as determined by the global positioning system; and
configuring the sensor to draw a level of power corresponding to the calculated level of power that may be sourced by the solar collector.
